(19) United States
(12) Patent Application Publication
(10) Pub. No.: US 2026/0221514 A1
(43) Pub. Date: Jul. 30, 2026

(54) PREPARATION PROCESS FOR ALL-SOLID-STATE BATTERIES

(71) Applicant: SAINT-GOBAIN CERAMICS & PLASTICS, INC., WORCESTER, MA (US)

(72) Inventors: Thomas MARCHANDIER, AUBERVILLIERS (FR); Mathilde LAMBERT, AUBERVILLIERS (FR); Vladimir OUSPENSKI, AUBERVILLIERS (FR)

(21) Appl. No.: 19/141,977

(22) PCT Filed: Dec. 21, 2023
(86) PCT No.: PCT/IB2023/063104

§ 371 Date: Jun. 20, 2025

(30) Foreign Application Priority Data
Dec. 21, 2022 (EP) 22215522.8

(51) Int. Cl. H01M 10/058; H01M 10/0525; H01M 10/0562

(52) U.S. Cl. CPC H01M 10/058; H01M 10/0525; H01M 10/0562; H01M 2300/008

(57) ABSTRACT

A preparation processes of an all-solid-state-battery (ASSB) element or of an ASSB including a halide solid electrolyte, wherein the processes includes a procedure of oxidation and an outgassing procedure.

### TECHNICAL FIELD

The present invention belongs to the field of all-solid-state rechargeable batteries (ASSB) and in particular relates to a preparation process of said ASSBs containing a halide solid electrolyte.

### TECHNICAL BACKGROUND

ASSBs are of particular interest as a substitute to traditional Li-Ion batteries, especially since they raise fewer safety concerns and have higher capacities or energy density.

To obtain an ASSB, a solid electrolyte is used instead of the liquid electrolytes found in Li-Ion batteries. ASSBs also use Li-metal anodes and high energy NMC cathode particles, said particles being incorporated into the solid state electrolyte.

Such solid electrolyte is for example chosen from lithium thiophosphate (β-Li₃PS₄, LPS), argyrodite (Li₆PS₅Cl) such as described in H. J. Deiseroth, et al. “Li₆PS₅X: a class of crystalline Li-rich solids with an unusually high Li+ mobility.” Angew. Chem. Int. Ed., 47 (2008), pp. 755-758 and halides, for example Li₃InCl₆, such as described in X. Li et al. “Air-stable Li₃InCl₆ electrolyte with high voltage compatibility for all-solid-state batteries.” Energy Environ. Sci., 2019,12, pp. 2665-267; Schmidt, M. O. et al. “Zur Kristallstruktur von Li₃InCl₆.” Zeitschrift für Anorg. und Allg. Chemie 1999, 625 (4), 539-540; and G. Meyer, et al. “Handbook on the Physics & Chemistry of Rare Earths”, V.28, chapter 177, 2000 Elsevier Sci.

However, the main drawback of these compounds is their chemical and electro-chemical interactions with electrode materials.

Halide solid electrolytes are of particular interest since they display good ionic conductivity (above 2 mS/cm) and a better compactibility (deformability) than other solid-state inorganic electrolytes. Among these compounds, multi-halide solid electrolytes, i.e. halide solid electrolytes comprising at least two halide ions, for example Cl and Br, are of particular interest since the heavier halides, such as Br and I, yield a high conductivity for the electrolyte, while lighter halides, such as Cl and F, have a higher electrochemical stability at high potential.

However, the inventors surprisingly discovered that when placing halide solid electrolytes, in particular multi-halide solid electrolytes, at high potential, species are formed from the degradation of the electrolytes. Said species have been identified to be halogenated molecular species such as Br₂ and I₂.

These species are very oxidizing and could lead to a reaction with different elements of the ASSB such as its electrode active materials or the current collector, which would reduce the capacity or lifetime of the battery. Moreover, when said species are gaseous, they can induce potentially dangerous overpressures in the battery cell.

### SUMMARY OF THE INVENTION

### Technical Problem

As identified by the inventors, the in situ formation of species could lead to several problems.

The invention thus offers to remedy to the above identified technical problems by:
improving the battery safety,
improving the battery capacity and lifetime,
enabling the use of halide solid electrolytes and in particular multi-halide solid electrolytes in ASSBs.

The present invention is further easily implemented in a preparation process, in particular at an industrial scale, of an ASSB element or of an ASSB itself.

By preparation process, it is understood that is designated any process that is designed to “prepare” the ASSB element or the ASSB itself, i.e. so that it may be used and/or function properly after undergoing the process according to the invention.

### Solution to the Technical Problem

Thus, according to a first aspect, the present invention relates to a preparation process of an all-solid-state-battery element comprising a halide solid electrolyte, characterized in that the process comprises:
a) a step of oxidation of the all-solid-state-battery element, and
b) an outgassing step.

An oxidation step according to the present invention may be carried on by applying a tension or advantageously in the case of an ASSB element, by treating it with an oxidizing gas such as Cl₂.

According to a second aspect, the present invention is also about a preparation process of an all-solid-state-battery comprising successively an anode, at least one electrolyte layer and a cathode, a halide solid electrolyte being comprised in at least one of the electrolyte layer(s) and/or in the cathode, wherein the process comprises:
a) a step of applying a tension U to the all-solid-state-battery, wherein

$$U = E + {E}_{ref}$$

with
E_{ref}, the potential difference between the anode and a lithium metal anode and
E a tension ranging from 3.0 V to 5.5 V, in particular ranging from 3.5 V to 4.0 V, and preferably from 4.0 V to 4.5 V, and
b) an outgassing step as defined in the present text.

The present invention also concerns both an all-solid-state-battery element comprising a halide solid electrolyte and an all-solid-state-battery obtained with processes according to the invention.

The outgassing steps implemented in the processes according to the invention allow to eliminate the species formed in situ, under normal usage conditions, from a battery cell.

### Advantages of the Invention

Firstly, by eliminating said species, the internal pressure of a battery cell is reduced so as to prevent any leakage.

Moreover, said species are strong oxidants which can react with several elements of an ASSB such as the electrode active materials, e.g. Lithium-Nickel-Manganese-Cobalt oxides at the cathode, or the current collector. The present invention allows to prevent such reaction by removal of said species and thus prevent any related reduction of the capacity and/or life of an ASSB.

Furthermore, multi-halide solid electrolytes are of particular interest because they can combine the high conductivity of the heavier halides and the stability of the lighter ones through a passivation mechanism. However, said passivation leads to the formation of the said species which are the main drawback of the multi-halide solid electrolytes. The present invention thus enables the use of said materials without negatively impacting the resulting ASSB.

Finally, the present invention is easily implemented into a battery production line. Indeed, while the need for outgassing was not yet identified for ASSBs, an outgassing step is commonly implemented for Li-ion batteries to remove the gas formed during the battery formation stage.

As reported in Deng, Z., Joule, 4, 2020, 2017-2029, in a Li-ion battery, the reduction of the liquid electrolyte at the negative electrode leads to the formation of a solid-electrolyte-interface (SEI) and to carbonaceous gases. Industrially, these gases are eliminated during the first cycles of the battery.

However, to the best knowledge of the inventors, in ASSBs, the decomposition of the electrolyte into different species is unexpected and it is commonly accepted that an outgassing step, which could also be referred to as a degassing step, is not necessary (see for example Fraunhofer ISI, Solid-state battery roadmap 2035+, April 2022).

Strauss, F, ACS Appl. Mater. Interfaces 2020, 12, 20462-20468 reported some cases of gases formation in ASSB also identified in Li-ion batteries. However, this gas formation results from the degradation of the cathode active material. On the other hand, the present invention does not pertain to the cathode active material as it concerns itself only with the species formed by a controlled electrochemical preparation of a halide solid electrolyte that takes place before any actual cycling.

### BRIEF DESCRIPTION OF THE DRAWINGS

FIG. 1 is a graphical representation of the cyclic voltammetry performed in the examples below on a) a pristine cell, corresponding to the comparative example 1 and b) a degassed cell, corresponding to the example 2 according to the invention, wherein the x-axis represents the potential applied to the cell and the y-axis represents the intensity of the measured current.

### DETAILED DESCRIPTION OF EMBODIMENTS

The present invention can be implemented for any ASSB element comprising a halide solid electrolyte. ASSB element could mean any element found in an ASSB or suitable for obtaining an ASSB from it. Preferably, the present invention is suitable for an electrolyte layer, a catholyte, i.e. the mixture of a cathode active material and an electrolyte, or the electrolyte material itself. The electrolyte material may be in the form of a powder, of a paste containing said powder or of a slurry.

Accordingly, an ASSB element or an ASSB obtained with a process according to the invention may comprise the halide solid electrolytes as detailed herein after.

In an ASSB according to the invention or implemented in a process according to the invention, the halide solid electrolyte may be comprised in the cathode and/or in the electrolyte layer.

### Halide Solid Electrolytes

Halide solid electrolytes may be represented by the following chemical formula

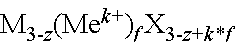

wherein −3≤z≤3,
k is the valence of Me and 2≤k<6, 0≤f≤1;
   M comprises an alkali metal element, in particular including Li;
   Me comprises a metal other than an alkali metal, and
   X is a halogen.

In a particular embodiment, f is different from zero.

In a particular embodiment, Me comprises more than one metal element and k may be the average of the total of the valence of each metal element. For example, when Me includes a trivalent element and a tetravalent element in equal molar quantity, k=(3+4)/2=3.5. In particular, k may be 2, 3, 4 or 5.

It is understood that atomic vacancy can be present inside the unit cell of the halide solid electrolyte. In this case, atomic vacancy can be noted in the formula of the solid halide electrolyte as M_{3-z}(Me^{k+})_{f●y}X_{3-z+k*f} wherein ● represents atomic vacancy inside the unit cell and y is the number of vacant atomic positions. In a particular embodiment, y can be f*(k−1).

In a particular embodiment, M can include Li, Na, K, Rb, Cs, or any combination thereof. For example, M can include at least one of Li and Na, or a combination thereof. In a further aspect, M can consist of at least one alkali metal element. For example, M can consist essentially of at least one alkali metal element chosen from the group consisting of Li, Na, K, Rb and Cs. In another example, M can consist of Li. In yet another example, M can consist of a combination of Li and at least one of Na, K, Rb and Cs. In still another example, M can consist of Na and at least one of Cs and Rb. In another example, M can consist of at least one of Na and Cs.

In a particular embodiment, Me can include an alkaline earth metal element, a rare earth element, a 3d transition metal, an element chosen from Zr, Ti, Sn, Th, Ge, Ta, Nb, Mo, W, Sb, Te, In, Bi, Al, Ga, and any combination thereof. For example, Me can include an alkaline earth metal including Ba, Mg, Ca and Sr, or any combination thereof. In another example, Me can include a rare earth element, in particular Me can consist of at least one rare earth element. The rare earth element may be chosen from Y, Sc, Ce, Gd, Er, La, Yb and their combinations. In a further example, Me can include a 3d transition metal, in particular chosen from Zn, Cu, V and any combination thereof. In still another example, Me can include an element chosen from Zr, Ti, Sn, Th, Ge, Ta, Nb, Mo, W, Sb, Te, In, Bi, Al, Ga and any of their combinations.

In a particular embodiment, X can include a halogen, in particular chosen from Cl, Br, I and any combination thereof. In an example, X can include at least one of Cl and Br. Preferably, X can consist of Cl, Br or any combination thereof. In a particularly preferred embodiment, X consists of Cl and Br.

Accordingly, an all-solid-state-battery element or an all-solid-state-battery according to the invention or implemented in a process according to the invention may comprise a halide solid electrolyte of the formula

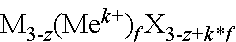

wherein −3≤z≤3, 2≤k<6, 0≤f≤1;
M comprises an alkali metal element, in particular including Li;
Me comprises a divalent, trivalent, tetravalent, pentavalent or hexavalent metal element or any combination thereof, in particular Me is chosen from:
   i. alkaline earth metals, including Ba, Mg, Ca, Sr,
   ii. rare earth elements such as Y, Sc, Ce, Gd, Er, La, Yb and their combinations,
   iii. a 3d transition metal such as Zn, Cu, V, and
   iv. an element chosen from Zr, Ti, Sn, Th, Ge, Ta, Nb, Mo, W, Sb, Te, In, Bi, Al, Ga, and
   v. any combination thereof, and
X is a halogen, in particular chosen from Cl, Br, I and any combination thereof;
   preferably the halide solid electrolyte is chosen from Li₃InCl₆ and Li₃Y(Cl,Br)₆.

In the present text, it is understood that, for example in Li₃Y(Cl,Br)₆, (Cl,Br)₆ means that any combination of Cl and Br may be present in the compound wherein the sum of the stoichiometric coefficients of Cl and Br is equal to 6.

In a particular embodiment, the halide solid electrolyte can be represented by Li_{3-z}Me^{k+}X_{3-z+k}. When z is not 0, the complex metal halide can be non-stoichiometric. When z is 0, the complex metal halide can be stoichiometric. For example, −0.95≤z≤0.95. In another example, Me includes Y, Gd, Yb, In, Sc, Zn, Mg, Ca, Ba, Sn or a combination thereof, and X is Cl, Br or a combination thereof.

In a particular embodiment, the halide solid electrolyte is a multi-halide solid electrolyte, in particular comprising at least one of Cl and F and at least one of Br and I, preferably the halide solid electrolyte comprises at least Cl and Br.

In the present text, by “multi-halide solid electrolyte(s)”, it is understood that are designated halide solid electrolyte(s) comprising at least two halide ions.

In a particular embodiment, the solid halide electrolyte can be represented by Li₃MeBr₆. In another particular embodiment, the solid halide electrolyte can be represented by Li₃MeCl₆. In a preferred embodiment, the solid halide electrolyte can be represented by Li₃Me(Cl,Br)₆. In these embodiments, Me can consist of at least one of the above-mentioned metal elements, having a valence of 3. Me can include at least one of the above-mentioned metal elements, wherein the average valence of the at least one metal element is 3.

In another particular embodiment, the solid halide electrolyte can consist of Li, Y, In and at least one of Cl and Br. For example, the solid halide electrolyte can consist of Li, Y, In and Cl. In another example, the solid halide electrolyte can consist of Li, Y, In and Br. In a preferred example, the solid halide electrolyte can consist of Li, Y, In, Cl and Br. In a particular example, the solid halide electrolyte can be represented by Li₃ₓ(Y,In)₁₋ₓCl₃, Li₃ₓ(Y,In)₁₋ₓBr₃ or Li₃ₓ(Y,In)₁₋ₓ(Cl,Br)₃, wherein 0<x≤0.5.

In another particular embodiment, the solid halide electrolyte can consist of Li, Y, and at least one of Cl and Br. For example, the solid halide electrolyte can consist of Li, Y and Cl. In another example, the solid halide electrolyte can consist of Li, Y and Br. In still another example, the solid halide electrolyte can consist of Li, Y, Cl and Br. In a particular example, the solid halide electrolyte can be represented by Li₃ₓY₁₋ₓCl₃, Li₃ₓY₁₋ₓBr₃ or Li₃ₓY₁₋ₓ(Cl,Br)₃, wherein 0<x≤0.5.

In another particular embodiment, the solid halide electrolyte can consist of Li, Gd and at least one of Cl and Br. For example, the solid halide electrolyte can consist of Li, Gd and Cl. In another example, the solid halide electrolyte can consist of Li, Gd and Br. In still another example, the solid halide electrolyte can consist of Li, Gd, Cl and Br. In a particular example, the solid halide electrolyte can be represented by Li₃ₓGd₁₋ₓCl₃, Li₃ₓGd₁₋ₓBr₃ or Li₃ₓGd₁₋ₓ(Cl,Br)₃, wherein 0.01≤x<1.

In another particular embodiment, the solid halide electrolyte can consist of Li, In, and at least one of Cl and Br. For example, the solid halide electrolyte can consist of Li, In and Cl. In another example, the solid halide electrolyte can consist of Li, In and Br. In still another example, the solid halide electrolyte can consist of Li, In, Cl and Br. In a particular example, the solid halide electrolyte can be represented by Li₃ₓIn₁₋ₓCl₃, Li₃ₓIn₁₋ₓBr₃ or Li₃ₓIn₁₋ₓ(Cl,Br)₃, wherein 0≤x<0.5.

The solid halide electrolyte may be chosen from Li₃InCl₆, Li₃InBr₆, Li₃In(Cl,Br)₆, Li₃YCl₆, Li₃YBr₆, Li₃Y(Cl,Br)₆, Li_{2.7}Y_{0.7}Zr_{0.3}Cl₆, Li_{2.8} Y_{0.8}Sn_{0.2}Cl₆, Li_{3.2}Y_{0.8}Zn_{0.2}Cl₆, Li_{3.2}Y_{0.8}Mg_{0.2}Cl₆, Li₃Y_{1/3}Zr_{1/3}Mg_{1/3}Cl₆, Li₃Y_{1/3}Sn_{1/3}Mg_{1/3}Cl₆, Li₃Y_{1/3}Zr_{1/3}Zn_{1/3}Cl₆, Li_{2.95}Na_{0.05}YBr₆, Li_{2.95}K_{0.05}YBr₆, Li_{2.95}Cs_{0.05}YBr₆, Li₃Y_{0.7}Gd_{0.3}Br₆, Li₃Y_{0.8} Yb_{0.2}Br₆, Li₃Y_{0.9}La_{0.1}Br₆, Li_{2.9}Y_{0.9}Ce_{0.1}Br₆ or Li₃In_{0.5}Y_{0.5}Cl₆.

The solid halide electrolyte may be chosen from Li₃InCl₆, Li₃InBr₆, Li₃In(Cl,Br)₆, Li₃YCl₆, Li₃YBr₆, Li₃Y(Cl,Br)₆, Li_{2.7}Y_{0.7}Zr_{0.3}Cl₆, Li_{2.8} Y_{0.8}Sn_{0.2}Cl₆, Li_{3.2} Y_{0.8}Zn_{0.2}Cl₆, Li_{3.2}Y_{0.8}Mg_{0.2}Cl₆, Li₃Y_{1/3}Zr_{1/3}Mg_{1/3}Cl₆, Li₃Y_{1/3}Sn_{1/3}Mg_{1/3}Cl₆, Li_{2.95}Na_{0.05} YBr₆, Li₃Y_{1/3}Zr_{1/3}Zn_{1/3}Cl₆, Li_{2.95}K_{0.05}YBr₆, Li_{2.95}Cs_{0.05}YBr₆, Li₃Y_{0.7}Gd_{0.3}Br₆, Li₃Y_{0.8} Yb_{0.2}Br₆, Li₃Y_{0.9}La_{0.1}Br₆, Li_{2.9}Y_{0.9}Ce_{0.1}Br₆ or Li₃In_{0.5}Y_{0.5}Cl₆, Li₃Y_{0.75}In_{0.25}Cl₄Br₂, Li₃Y_{0.8}In_{0.2}Cl₄Br₂, Li₃Y_{0.85}In_{0.15}Cl₄Br₂, Li₃Y_{0.9}In_{0.1}Cl₄Br₂, Li₃Y_{0.85}In_{0.15}Cl_{3.5}Br_{2.5} and Li₃Y_{0.985}In_{0.015}Cl₄Br₂.

### Anode

In an ASSB, the anode active material is a material capable of storing and releasing metal ions, in particular alkali metal ions such as Li or Na ions.

As the anode active material metals, carbon, oxides or nitrides may be used.

Metals suitable for use as an anode active material may be a single metal or an alloy such as lithium metal or a lithium alloy. Metals suitable for use as an anode active material may be chosen from silicon, tin, a silicon compound, a tin compound, lithium and a lithium alloy.

Examples of carbon suitable for use as an anode active material include natural graphite, coke, developing carbon, carbon fibers, spheroidal carbon, artificial graphite and amorphous carbon.

Accordingly, in an all-solid-state battery according to the invention or implemented in a process according to the invention, the anode active material may be chosen from
oxides,
nitrides,
carbon such as natural graphite, coke, developing carbon, carbon fibers, spheroidal carbon, artificial graphite and amorphous carbon,
metals such as silicon, tin, sodium or lithium, their compounds and their alloys,
in particular, the anode active material is chosen from silicon, tin, lithium, their compounds and their alloys such as LiₓIn_{y} wherein x ranges from 0 to 1 and y ranges from 0 to 1, preferably the anode active material is Li_{0.5} In or lithium.

The thickness of the anode in an ASSB according to the invention or implemented in a process according to the invention may range from 10 μm to 500 μm.

At least one of the anode and the cathode may comprise an electron conductor compound chosen from natural or artificial graphite, graphene, carbon nano-tubes, acetylene black, Ketjen black, activated carbon, carbon fluoride, metal powders, conductive whiskers, conductive metal oxides, conductive polymers, metal fibres or carbon fibres, preferably the electron conductor is vapour grown carbon fibres.

### Cathode

In an all-solid-state battery according to the invention or implemented in a process according to the invention, the cathode composite may comprise a cathode active material and a halide solid electrolyte as described herein above.

The cathode active material is a material capable of storing and releasing metal ions, in particular alkali metal ions such as Li or Na ions.

As cathode active materials transition metal fluorides, polyanionic materials, fluorinated polyanionic materials, transition metal sulphides, transition metal oxyfluorides, transition metal oxysulphides, transition metal oxynitrides and lithium-containing transition metal oxide, doped or not, coated or not may be used. In particular, the cathode active material may be a transition metal oxide such as a lithium-cobalt oxide, a lithium-nickel-cobalt-aluminium oxide or a lithium-nickel-manganese-cobalt-oxide. Transition metal oxides suitable for use as a cathode active material may be, for example, LiNi_{0.6}Mn_{0.2}Co_{0.2}O₂, Li(NiCoAl)O₂ and LiCoO₂. Preferably, the cathode active material is the transition metal oxide of the formula LiNi_{0.6}Mn_{0.2}Co_{0.2}O₂ or LiNi_{0.8}Mn_{0.1}Co_{0.1}.

The cathode active material may be present in a ASSB according to the invention, in the form of particles. The median diameter of the anode active material particles may range from 0.1 μm to 100 μm. Preferably, the median diameter of the anode active material particles is larger than the median diameter of the solid electrolyte particles.

The thickness of the anode in an ASSB according to the invention or implemented in a process according to the invention may range from 10 μm to 500 μm.

At least one of the anode and the cathode may comprise an electron conductor compound chosen from natural or artificial graphite, graphene, carbon nano-tubes, acetylene black, Ketjen black, activated carbon, carbon fluoride, metal powders, conductive whiskers, conductive metal oxides, conductive polymers, metal fibres or carbon fibres, preferably the electron conductor is vapour grown carbon fibres.

Accordingly, in an all-solid-state-battery according to the invention or implemented in a process according to the invention, the cathode may comprise a cathode active material chosen from transition metal fluorides, polyanionic materials, fluorinated polyanionic materials, transition metal sulphides, transition metal oxyfluorides, transition metal oxysulphides, transition metal oxynitrides and lithium-containing transition metal oxide, doped or not, coated or not, in particular the cathode active material is a transition metal oxide such as a lithium-cobalt oxide, a lithium-nickel-cobalt-aluminium oxide or a lithium-nickel-manganese-cobalt-oxide, preferably of the formulae LiNi_{0.6}Mn_{0.2}Co_{0.2}O₂ or LiNi_{0.8}Mn_{0.1}Co_{0.1}.

### Preparation Process

An all-solid-state battery element or an all-solid-state battery according to the invention or implemented in a process according to the invention is obtained firstly though steps known to the person skilled in the art to obtain said element or ASSB comprising the desired materials.

The present invention lies in further adding to processes known in the art outgassing steps. In the present text “outgassing steps”, used in the plural form, is meant to include both a step of oxidation, in particular, in the case of an ASSB, of applying a tension, and the actual outgassing step.

Said outgassing steps aim at removing any specie formed by electrochemical reaction within an ASSB, in particular by the electrochemical reaction of a halide solid electrolyte, preferably a multi-halide solid electrolyte, comprised in the anode and/or the electrolyte layer(s) of an ASSB.

As illustrated by the description of the halide solid electrolytes suitable for the invention, the specie formed may be halogenated molecular species, i.e. F₂, Cl₂, Br₂ and I₂.

In a preferred embodiment of the invention, the outgassing step comprises eliminating halogenated molecular species, in particular Cl₂, Br₂ and/or I₂ and preferably Br₂ and/or I₂.

By “eliminating” it is understood that is meant the removal of said specie from the contact of the ASSB element or of the ASSB, for example in the case of an ASSB, the removal of the specie from the casing.

Said oxidation step may be carried on for a duration ranging from 10 minutes to 10 hours, in particular ranging from 30 minutes to 5 hours, and preferably ranging from 45 minutes to 3 hours.

Said oxidation step may comprise treating an ASSB element as defined above with an oxidizing gas such as Cl₂. Such a treatment may be carried out in a furnace, preferably a tubular furnace, initially filled with an inert gas such as nitrogen, argon or a mixture thereof; gaseous Cl₂ may then be introduced, for example at a pressure ranging from 0.1 to 10 mbar, and the furnace may be heated to a temperature ranging from 100 to 300° C. for a duration corresponding to the duration of the oxidation step as described above. When the gas flow is stopped, the furnace may be evacuated to a pressure ranging from 10⁻⁵ to 10⁻³ for a duration ranging from 2 to 30 minutes. The ASSB element may then be introduced into an inert atmosphere, for example substantially consisting of nitrogen, argon or a mixture thereof, such as a glovebox.

Said tension is a tension U, defined by the relation

$$U = E + {E}_{ref}$$

where
E_{ref} is the potential difference between the anode of the ASSB and a lithium metal anode and
E is a tension ranging from 3.0 V to 5.5 V, in particular ranging from 3.5 V to 4.0 V, and preferably from 4.0 V to 4.5 V.

In a particular embodiment of the invention, the tension U is applied for a duration ranging from 10 minutes to 10 hours, in particular ranging from 30 minutes to 5 hours, and preferably ranging from 45 minutes to 3 hours.

When applied to an ASSB element, said outgassing step may comprise, preferably consist in, placing the all-solid-state-battery element under dynamic vacuum.

When applied to an ASSB, said outgassing step may comprise, preferably consist in, opening the battery cell and placing the obtained opened cell under dynamic vacuum.

In both cases, said dynamic vacuum may be maintained at a pressure ranging from 10⁻³ mbar to 10⁻¹ mbar, in particular ranging from 5.10⁻³ mbar to 5.10⁻² mbar, and preferably from 7.10⁻³ mbar to 2.10⁻² mbar.

In a particular embodiment of the invention, the outgassing step is carried on for a duration ranging from 1 minute to 10 hours, in particular ranging from 5 minutes to 5 hours, and preferably ranging from 10 minutes to 3 hours.

In a particular embodiment of the invention, the outgassing step may occur at a temperature ranging from 15° C. to 70° C., in particular from 20° C. to 50° C. and preferably from 25° C. to 40° C.

In a particular embodiment of the invention, after the outgassing step, the battery is closed and preferably pressed at a pressure ranging from 250 kg·cm⁻² to 3000 kg·cm⁻², in particular from 500 kg·cm⁻² to 1500 kg·cm⁻².

The battery may be closed and pressed under an inert atmosphere, preferably under argon.

The process according to the invention will further be illustrated through the examples below.

### Comparative Example 1

The cell assembly was carried out in a cell consisting of a cylindrical polyetherimide (PEI) cell body and two stainless steel pistons of 8 mm diameter.

The assembling procedure was carried out under argon atmosphere in a glove box ([O₂]<1 ppm, [H₂O]<1 ppm).

The two-electrode cell was assembled as follows.

80 mg of Li₃YCl₄Br₂ was spread and cold pressed at 250 kg·cm⁻².

10 mg·cm⁻² of cathode composite (Li₃YCl₄Br₂/carbon super C65 in a 90:10 ratio) was spread onto a surface of the pressed Li₃YCl₄Br₂ at the cathode side. The stack was then further densified at 1100 kg·cm⁻² for 15 minutes.

Next, a lithium indium composite of formula Li_{0.5} In was added the opposing side, the anode side, of the Li₃YCl₄Br₂ pellet as counter electrode.

Finally, the whole stack was further densified at 4 t/cm² for 15 minutes. After the compression, a pressure of 1100 kg·cm 2 was applied on the fully assembled cell for electrochemical studies.

### Example 2 According to the Invention

The cell of example 2 was obtained according to the protocol detailed in the comparative example 1.

After its assembly, the cell was charged up to 4.5 V and this voltage was held for 1 hour. The battery was then opened at the cathode side by removing one of the stainless-steel pistons and placed at a 10-2 mbar dynamic vacuum for 1 hour.

After this vacuum treatment, the cell was closed once again at 1100 kg·cm⁻².

### Cyclic Voltammetry

The cells of the comparative example 1 and of the example 2 according to the invention were cycled between 1.6 V and 4.5 V with a 0.5 mV·s⁻¹ rate.

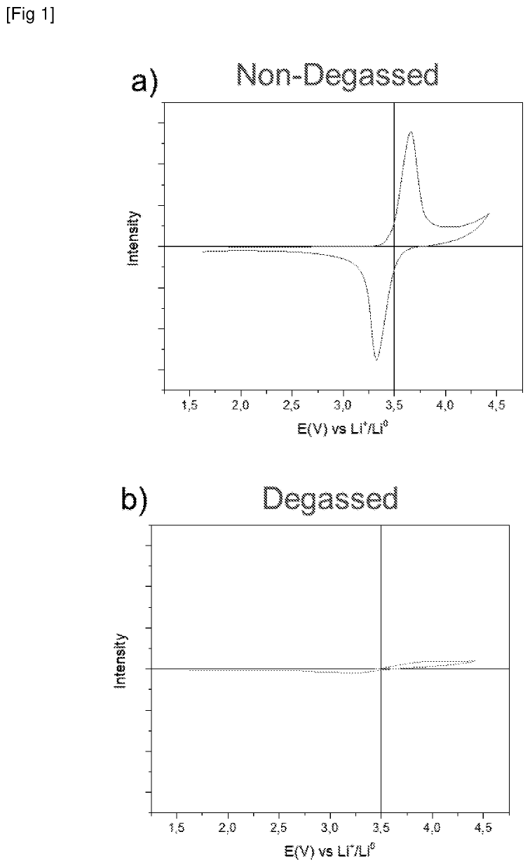

The graphical representation of the cyclic voltammetry is presented in FIG. 1 wherein the graph a) corresponds to the comparative example 1 and the graph b) corresponds to the example 2 according to the invention.

While part a) of FIG. 1 indicates that a reversible electrochemical process is occurring within the cell, part b) of said FIG. 1 shows almost no electrochemical activity. This demonstrates that the specie responsible for the electrochemical signature in the pristine cell of the comparative example 1 was eliminated through vacuum.

### Example 3 According to the Invention

The battery assembly was carried out in a cell consisting of a cylindrical polyetherimide (PEI) cell body and two stainless steel pistons of 8 mm diameter.

The assembling procedure was carried out under argon atmosphere in a glove box ([O₂]<1 ppm, [H₂O]<1 ppm).

The two-electrode cell using a LiIn alloy anode was assembled as follows.

80 mg of Li₃YCl₄Br₂ was spread and cold pressed at 1100 kg·cm⁻².

10 mg·cm⁻² of cathode composite (NMC811/Li₃YCl₄Br₂/carbon super 65 in a 75:24:1 ratio) was spread onto a surface of the pressed Li₃YCl₄Br₂ at the cathode side. The stack was then further densified at 1100 kg·cm⁻² for 15 minutes.

Next, a lithium indium composite of formula Li_{0.5} In was added the opposing side, the anode side, of the Li₃YCl₄Br₂ pellet. Finally, the cell was closed at 1100 kg·cm⁻².

The battery was then maintained at 4.3 V for 1 hour before being opened and placed under dynamic vacuum at 10⁻² mbar for 1 hour.

The battery was then closed again and repressed at 1100 kg·cm⁻² before being cycled at room temperature with a C/20 speed between 1.8 V and 4.3 V.

1. A preparation process of an all-solid-state-battery element comprising a halide solid electrolyte, the process comprising:
a) a step of oxidation of the all-solid-state-battery element, and
b) an outgassing step.

2. The preparation process according to claim 1, wherein the outgassing step comprises eliminating halogenated molecular species.

3. The preparation process according to claim 1, wherein the oxidation step is carried on for a duration ranging from 10 minutes to 10 hours.

4. The preparation process according to claim 1, wherein the outgassing step comprises placing the all-solid-state-battery element under dynamic vacuum.

5. The preparation process according to claim 4, wherein the dynamic vacuum is maintained at a pressure ranging from 10⁻³ mbar to 10⁻¹ mbar.

6. The preparation process according to claim 1, wherein the outgassing step is carried on for a duration ranging from 1 minute to 10 hours.

7. The preparation process according to claim 1, wherein the outgassing step occurs at a temperature ranging from 15° C. to 70° C..

8. The preparation process according to claim 1, wherein the halide solid electrolyte is of the formula 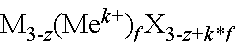
wherein −3≤z≤3, 2≤k<6, 0≤f≤1;
M comprises an alkali metal element;
Me comprises a divalent, trivalent, tetravalent, pentavalent or hexavalent metal element or any combination thereof,
and
X is a halogen.

9. The preparation process according to claim 1, wherein the halide solid electrolyte is a multi-halide solid electrolyte.

10. A preparation process of an all-solid-state-battery, said all-solid-state-battery comprising successively an anode, at least one electrolyte layer and a cathode, a halide solid electrolyte being comprised in at least one of the electrolyte layer(s) and/or in the cathode, the preparation process comprising:
a) a step of applying a tension U to the all-solid-state-battery, wherein
$$U = E + {E}_{ref}$$
with
E_{ref}, a potential difference between the anode and a lithium metal anode and E a tension ranging from 3.0 V to 5.5 V, and
b) an outgassing step as defined in claim 1.

11. The preparation process according to claim 10, wherein the tension U is applied for a duration ranging from 10 minutes to 10 hours.

12. The preparation process according to claim 11, wherein the outgassing step comprises opening the battery cell and placing the obtained opened cell under dynamic vacuum.

13. The preparation process according to claim 10, wherein, after the outgassing step, the battery is closed.

14. The preparation process according to claim 10, wherein the cathode comprises a cathode active material chosen from transition metal fluorides, polyanionic materials, fluorinated polyanionic materials, transition metal sulphides, transition metal oxyfluorides, transition metal oxysulphides, transition metal oxynitrides and lithium-containing transition metal oxide, doped or not, coated or not.

15. The preparation process according to claim 10, wherein the anode comprises an anode active material chosen from:
oxides,
nitrides,
carbon,
metals.

16. An all-solid-state-battery element or an all-solid-state-battery obtained with a process according to claim 1.

17. The preparation process according to claim 2, wherein the halogenated molecular species are Cl₂, Br₂ and/or I₂.

18. The preparation process according to claim 3, wherein the duration ranges from 30 minutes to 5 hours.

19. The preparation process according to claim 4, wherein the outgassing step consists in placing the all-solid-state-battery element under dynamic vacuum.

20. The preparation process according to claim 5, wherein the dynamic vacuum is maintained at a pressure ranging from 5.10⁻³ mbar to 5.10⁻² mbar.
